(19) United States
(12) Patent Application Publication
(10) Pub. No.: US 2015/0051066 A1
(43) Pub. Date: Feb. 19, 2015

(54) On-Line Sulfiding Apparatus and Process

(71) Applicant: ExxonMobil Chemical Patents Inc., Baytown, TX (US)

(72) Inventors: Robert G. Tinger, Friendswood, TX (US); John J. Monson, League City, TX (US)

(21) Appl. No.: 14/335,112

(22) Filed: Jul. 18, 2014

Related U.S. Application Data
(60) Provisional application No. 61/866,729, filed on Aug. 16, 2013.

(51) Int. Cl. B01J 27/051; B01J 27/043; B01J 27/045; B01J 27/04

(52) U.S. Cl. CPC B01J 27/051; B01J 27/04; B01J 27/043; B01J 27/045
USPC 502/220; 422/211; 502/216; 502/222; 502/223

(57) ABSTRACT

An apparatus and process for passivating catalysts wherein an inert gas is used to administer a precise, measurable amount of passivating agent to a catalyst in a substantially safer manner than conventional means. The inventive apparatus at least includes a first container comprising at least one inert gas, a second container comprising at least one passivating agent, and a reactor comprising at least one catalyst, the first container, second container, and reactor being fluidly connected by a plurality of conduits. The inventive process at least includes pressurizing a first container with an inert gas, filling a second container with passivating agent, providing a reactor containing a passivatable catalyst, mixing the inert with the passivating agent, forming a mixture of passivating agent and inert gas, and introducing the mixture of passivating agent and inert gas into the reactor.

### CROSS REFERENCE TO RELATED APPLICATIONS

This application claims the priority of U.S. Provisional Application No. 61/866,729, filed Aug. 16, 2013, the disclosure of which is incorporated herein by reference in its entirety.

### FIELD OF THE INVENTION

The invention relates to an apparatus and process for sulfiding catalysts containing hydrogenation metals.

### BACKGROUND OF THE INVENTION

Passivating is often required to temper the activity of catalysts containing hydrogenation metals. Fresh catalysts exhibit a very high metal activity which can lead to is high hydrogenation and hydrocracking rates if not properly managed. High gas make and/or elevated temperatures may result. A conventional approach to temper the hyper-activity of the hydrogenation metal on hydroprocessing units is to presulfide the catalysts prior to introduction of hydrocarbons (“oil-in”). Sulfur will sorb onto the hydrogenation metal to temper the activity of the metal. Low level concentrations of sulfur will desorb off the metal after oil is introduced while simultaneously coke will form and naturally passivate the hyper-activity of the metal. However, excessive sulfur use during start-up will permanently deactivate the metal function to the point where metal activity is significantly impacted, which results in higher aging rates, shorter catalyst cycles, and lower yields. FIG. 3 depicts the paraxylene selectivity for an isomerization catalyst and shows that the performance of an over-sulfided catalyst significantly decreases substantially sooner than the performance of a properly sulfide catalyst.

Conventional sulfiding process consists of the following steps: (i) load catalyst inside the reactor where the sulfiding is to occur, (ii) purge oxygen (O₂) from the catalyst per local specifications, (iii) heat the catalyst with make-up hydrogen and purge gas to both remove water and to reduce the hydrogenation metal under the presence of hydrogen per the catalyst manufacturers guidelines, (iv) presulfide the catalyst using a liquid hydrocarbon containing sulfur prior to oil-in until there is a breakthrough of H₂S downstream of the reactor, and (v) oil-in. Alternatively, presulfided catalysts may be introduced into an active reactor. U.S. Patent Application No. 2005-0006283-A1 discloses a process for presulfiding a catalyst using the conventional method of utilizing a heated hydrocarbon liquid. The application discloses the conventional sulfiding method in a way that allows for the introduction of presulfided catalysts to an active reactor without having to shut down the reactor to replace the catalyst. PCT Application No. PCT/EP00/05629 discloses the conventional method of presulfiding catalysts by utilizing liquid hydrocarbon streams. The disclosed process is described as being able to allow presulfided catalysts to be introduced to a reactor without interruption of continuous operation of the reactor.

Conventionally, the sulfiding agent is injected into the system using a mechanical pump, typically a positive displacement pump. The injection of sulfiding agent can be controlled by varying the stroke volume or the number of strokes. This can be very difficult to control and the amount of sulfur injected cannot be precisely controlled or monitored. Pumps are equipped with hydraulic in-line safety valves which can easily lift or leak, and the amount of sulfiding agent injected into the unit cannot be easily measured. Therefore, it is not precisely known exactly the amount of sulfur, if any, that is injected into the unit.

To determine if sulfur has been injected into the unit, sulfur in the form of H₂S, is measured at the outlet of the reactor. This requires taking a sample at the reactor outlet and measuring for H₂S. This is accomplished using a Draeger or Gastec tube (designed to measure H₂S) or using a solution of lead acetate or other alternatives. Conventional methods using a solution of lead acetate involve passing a stream across a solution of lead acetate whereby any sulfur present in the stream reacts with the lead acetate causing a color change, indicating the presence of sulfur in the stream. Such methods solely indicate whether sulfur is present, but do not indicate the quantity of sulfur present. These all require a gas stream to vent from the unit, with exposure of personnel to highly toxic and dangerous H₂S. Even here, measurements can be unreliable and sulfur injection can far exceed the amount required to passivate the hydrogenation metal if no signs of sulfur breakthrough are present. Alternatively, if a false-positive on sulfur breakthrough is detected, and insufficient amount of sulfiding agent has been added to the catalyst, a potential for high ring saturation/hydrocracking may result with the possibility of a large exotherm developing. The large exotherm may damage the catalyst or potentially equipment if not properly managed.

Therefore, there is a need for a process of sulfiding a catalyst in which the amount of sulfur injected can be measured in a safer manner.

### SUMMARY OF THE INVENTION

The invention is directed to an apparatus and process for passivating a hyperactive metal-containing catalyst, preferably by sulfiding the catalyst, in which the precise amount of sulfiding agent used may be simply and safely measured. A pressure vessel containing a known amount of sulfiding agent is connected to a reactor containing a hydrogenation metal catalyst. Pressure is provided by an inert gas to force the sulfiding agent into the unit. The amount of sulfur to inject can be calculated by one of ordinary skill in the art based on the activity of the catalyst. The precise amount of sulfiding agent administered may be measured by weighing the passivating agent container before and after the process for comparison, or during the process, or by an indicator on the container.

Advantages of the present invention, in embodiments, include at least one of the following: (i) ability to know that the passivating agent is/has been delivered to the catalyst; (ii) increased ability to know how much passivating agent has been delivered to the catalyst; and (iii) increased safety for operators.

### BRIEF DESCRIPTION OF THE DRAWINGS

FIGS. 1 and 2 are schematic illustrations of embodiments of the invention.

FIG. 3 depicts paraxylene (pX) selectivity for isomerization catalysts over time.

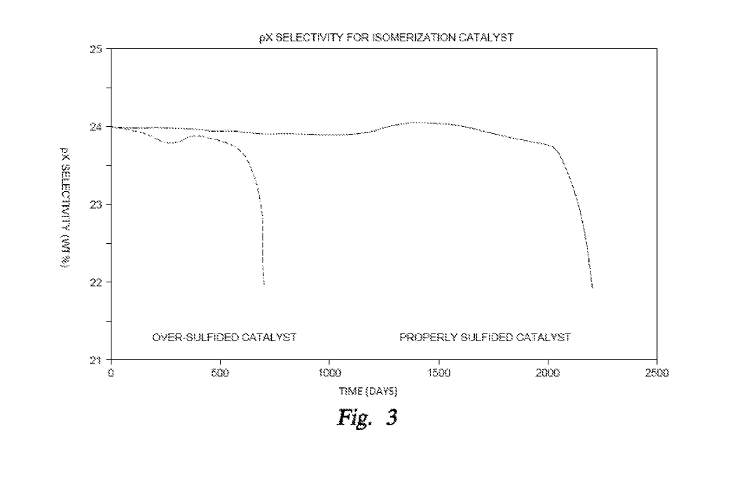

### DETAILED DESCRIPTION

The invention may be used to passivate catalysts which, on fresh start-up, are hyper-active. Because of their hyperactivity, the catalysts and hydrogenation metal will promote ring saturation and crack at very high levels. This reaction is exothermic, and the exotherm can exceed design temperatures of the equipment. Because of this, there exists a need to temper catalyst metal activity on fresh start-up. The appropriate catalysts to be used with the invention include all catalysts which are passivatable. Preferably this includes all hydrogenation metal catalysts. More specifically this includes catalysts comprised of Pt, Re, Co, Mo, Pd, Ni, Ir, Fe, and mixtures thereof.

An apparatus and process are provided for injecting a sulfiding agent into a reactor containing a hyperactive metal-containing catalyst to sulfide and therefore passivate the catalyst. Typically the injection of the sulfiding agent would be performed prior to oil-in. Advantages of the present invention, in embodiments, include at least one of the following: (i) ability to know that the passivating agent is/has been delivered to the catalyst; (ii) increased ability to know how much passivating agent has been delivered to the catalyst; and (iii) increased safety for operators. Additionally, the ability to precisely determine the amount of sulfiding agent administered to the catalyst without the need to take samples, eliminates the need for cumbersome sampling procedures, and reduces the chance of H₂S exposure to personnel. The present invention provides an improved, simpler method for introducing the sulfiding agent into the reactor system.

Additionally, the apparatus can be used to inject a sulfiding agent into the process, post oil-in as required to either temper high metal activity catalyst or hydrogenation catalyst that may cause undesirable side reactions. The invention provides further utility by allowing the introduction of a sulfiding agent to a presulfided catalyst without the need for shutdown or the use of large pumps. Traditionally, the use of such large pumps adds considerable difficulty to this type of process, therefore the ability to introduce a sulfiding agent to a presulfided catalyst adds considerable value to the field. In embodiments, the invention can be used to presulfide (prior to introduction of hydrocarbons) and/or can be used for sulfiding on-oil (when catalyst is exposed to hydrocarbon).

The invention aids in other ways including protecting from iron scale in piping. Iron scale, in the form of iron oxide (rust), forms when equipment is opened thereby exposing the equipment's interior to oxygen. Iron oxide scale promotes hydrogenation of aromatics to non-aromatics/naphthenes impacting product specifications. The present invention allows for is passivating the iron, reducing the chance of these undesirable effects. Other applications of the invention include injection of any liquid into a system including, for example, amines, tracer components, or water.

Terms used herein take their ordinary meaning in the art. For instance, passivating means the act of tempering the activity of a substance, while passivatable refers to the ability for a substance to be passivated. Typically, this is performed by the introduction of a passivating agent to the passivatable substance.

Passivating agent means a chemical which is administered to a catalyst to temper the activity of the catalyst in order to avoid undesirably high hydrogenation rates, hydrocracking rates, gas make, and/or temperatures. Preferably, the passivating agents include, but are not limited to, sulfiding agents including carbon disulfide, n-butyl mercaptan, ethyl mercaptan, di-tertiary nonyl polysulfide, dimethyl disulfide (DMDS), dimethyl sulfide (DMS), dimethyl sulfoxide (DMSO), and hydrogen sulfide (H₂S). Other examples include mercaptans or tert nonyl polysulfide (TNPS).

Inert gas means a gas that does not undergo chemical reactions under a set of given conditions. Preferably, this term is comprised of the noble gases (helium, neon, argon, krypton, xenon, and radon) and nitrogen. However, persons having ordinary skill in the art with possession of the invention would know other gases would not undergo reactions under certain conditions, including light alkanes (methane, ethane), H₂, and natural gas. In the preferred embodiments, helium is utilized.

Reactor means what a person having ordinary skill in the art would understand. Preferably, in this context, reactor refers to a vessel capable of being used for isomerization, alkylation, transalkylation, reforming, hydrotreating, hydrocracking, hydrofinishing, hydroprocessing or disproportionation reactions.

Conduit means any method of fluidly connecting a plurality of containers including the use of tubes or pipes.

### Apparatus

One embodiment of the invention provides an apparatus for passivating catalysts with increased precision and safety when compared to those apparatuses known in the prior art. Thus, utilizing the present apparatus, the amount of passivating agent introduced into the hydrogenation metal catalyst can be more accurately measured while simultaneously reducing the chance of accidental hazardous chemical exposure to the user. By pressurizing a series of conduits or tubing using an inert gas and the passivating agent, releasing said mixture into the reactor, and determining the amount of the passivating agent remaining in the container, precise determination of the amount of passivating agent can be calculated while not requiring the measurement of H₂S at the reactor outlet, which avoids potential exposure of harmful H₂S to personnel.

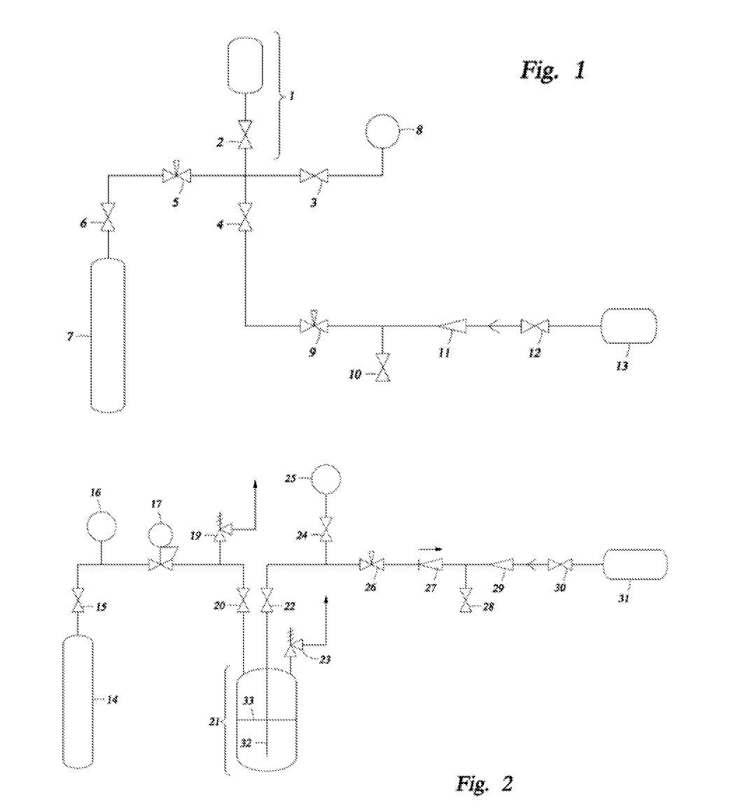

FIG. 1 depicts a generalized arrangement of components according to an embodiment of the invention. Passivating agent container 1 is fluidly connected to a pressure indicator 8, an inert gas container 7, and a reactor 13 by a plurality of conduits that meet at an intersection separate from any vessel. The apparatus contains a plurality of valves (2, 3, 4, 6, 10) in addition to a plurality of needle valves (5, 9) and a bleeder valve (12). One skilled in the art may determine the specific requirements of the valves and tubing, but in one embodiment, stainless steel tubing with a diameter of 0.125-0.5 inches (0.3175-1.27 cm), preferably 0.25 inches (0.635 cm) or 0.375 inches (0.9525 cm) is used. The system pressure is to be set by rating/relief systems of the inert gas and passivating agent containers. The rate of sulfur injection can be easily controlled using a restriction orifice or high precision valve with known characteristics. Such characteristics include metering valve sizing based on system pressure and rate of sulfiding desired. The injection point is located preferably as close to the reactor inlet as possible.

FIG. 2 depicts a second and more preferred arrangement of components according to an embodiment of the invention. Primary components of the apparatus are a container of inert gas 14, a container of passivating agent 21, and a reactor 31. The inert gas 14 feeds into the passivating agent container 21 which in turn feeds into the reactor 31. Between the inert gas 14 and the passivating agent container 21 preferably are two valves (15, 20), a pressure source 16, a pressure control valve 17, and a safety release valve 19. The passivating agent container 21 preferably includes some level 33 that delineates between the passivating agent and the gas within the container, a dip-tube 32 extending down into the passivating agent, and a safety release valve 23. Between the passivating agent container 21 and the reactor 31 preferably are a valve 22, a pressure indicator 25 with a corresponding valve 24, a needle control valve 26, a check valve 27, a valve that allows for clearing the system 28, a line expansion 29, and a bleeder valve 30.

A specific embodiment consists essentially of (i) a first container comprising at least one inert gas, (ii) a second container comprising at least one passivating agent, and (iii) a reactor comprising at least one catalyst, the first container, second container, and reactor being fluidly connected by a plurality of conduits. In this context “consisting essentially of” means the scope includes the specified components and/or steps and those that do not materially affect the basic and novel characteristics of invention. A small amount of is hydrocarbon would be within the scope provided that it does not materially affect the basic and novel characteristics of the invention, something which a person having ordinary skill in the art could determine without undue experimentation.

The components of the invented apparatus can be arranged in a plurality of layouts. FIG. 1 and FIG. 2 illustrate two such embodiments. FIG. 1 depicts an apparatus whereby the inert gas container 7 and the passivating agent container 1 meet at an intersection of conduits separate from any container. Alternatively, FIG. 2 depicts an embodiment whereby the inert gas container 14 is fluidly connected with the passivating agent container 21 which is then fluidly connected to the reactor 31 in such a way that the contents of the inert gas container 14 must pass through the passivating agent container 21 before reaching the reactor 31.

In another embodiment, the passivating agent and inert gas may be combined within a single container. Thus, the apparatus would consist essentially of a container comprising at least one passivating agent and at least one inert gas and a reactor comprising at least one catalyst, the container and reactor fluidly connected by a plurality of conduits.

### Process

The generalized process consists of the following steps: (i) pressurizing a first container with an inert gas, (ii) filling a second container with the desired amount of passivating agent, (iii) providing a reactor containing a passivatable catalyst, (iv) causing the inert gas to mix with the passivating agent, thereby pressurizing the passivating agent and forming a mixture of passivating agent and inert gas, and (v) introducing the mixture of passivating agent and inert gas into the reactor.

A more preferred embodiment of the process utilizes a sulfiding agent as the passivating agent, helium (He) as the inert gas, and is laid out in essentially the same setup as shown in FIG. 1. This preferred embodiment comprises the following steps: (i) fill sulfiding agent container 1 with desired sulfur concentration to be introduced to the system, (ii) pressure system to desired pressure (nominally 50-100 psig above system pressure) by opening valve 2 and needle valve 5 from helium supply 7 to the sulfiding agent container, keeping valves 3 and 5 open, and valve 4 closed, (iii) verify system pressure via gauge on valve 3, (iv) close helium supply needle valve 5, (v) open valve 12 to the reactor 13 and valve 4, (vi) open needle valve 9 to inject sulfiding agent at desired rate, (vii) inject until valve 3 pressure gauge indicates system has come to equilibrium, (viii) close valve 12 to the reactor 13, (ix) close valve 2, (x) disconnect sulfiding container 1 and weigh to ensure all sulfiding has been delivered to the system, (xi) clear system through valve 10 to a closed system, and is (xii) repeat sulfur injection as needed based on reactor performance.

Alternatively, another preferred embodiment of the process utilizes a sulfiding agent as the passivating agent, helium (He) as the inert gas, and is laid out in essentially the same setup as shown in FIG. 2. This preferred embodiment comprises the following steps: (i) fill sulfiding agent container 21 with desired sulfur concentration to be introduced into the reactor 31, (ii) open valve 15 but keep valve 20 closed to allow helium into the tubing between the helium source and the sulfiding agent container, (iii) achieve desired pressure of helium while having pressure control valve 17 and safety relief valve 19 as fail-safes, (iv) open valve 20 to allow helium into sulfiding agent container and achieve desired pressure, (v) open valves 22, needle valve 26, and bleeder valve 30 to allow sulfiding agent to be introduced into the reactor 31, (vi) close valve 20, (vii) determine amount of sulfiding agent still in the sulfiding agent container 21 to ensure all sulfiding agent was deposited into the reactor 31, (viii) clear system through valve 28 to a closed system, and (ix) repeat sulfur injection as needed based on reactor performance.

In an embodiment in which the passivating agent and inert gas are combined within a single container, the process comprises the following steps: (i) introducing a desired amount of passivating agent into a container, (ii) pressurizing the container with an inert gas, forming a mixture of passivating agent and inert gas, (iii) providing a reactor containing a passivatable catalyst, and (iv) introducing the mixture of passivating agent and inert gas into the reactor.

To achieve precision in the amount of passivating agent administered to the reactor, the invention may include a final step of measuring the amount of passivating agent remaining in the passivating agent container in order to calculate the precise amount administered through the use of the invention. This step can be performed in a plurality of ways. One such embodiment involves weighing the passivating agent container before beginning the process, weighing the passivating container after performing the process, and calculating the amount administered from the weight differential from the two. Alternatively, a gauge may be installed on the passivating agent container that indicates the amount of agent is contained within, thereby allowing the user to determine precisely how much is administered. Additional methods to determine the amount of passivating agent administered include: (i) opening the passivating agent container on inspection, (ii) adding a site glass to the passivating agent container, (iii) adding a pressure gauge to measure the liquid head, (iv) using sonar or other level measurement means, or (v) weighing the passivating agent container during the process while the passivating agent is being administered.

The description and examples above support one or more of the following more specific Embodiments.

Embodiment 1. An apparatus for passivating catalysts, consisting essentially of: (a) a first container comprising at least one inert gas; (b) a second container comprising at least one passivating agent; and (c) a reactor comprising at least one catalyst, wherein the first container, second container, and reactor are fluidly connected by a plurality of conduits.

Embodiment 2. The apparatus of Embodiment 1 wherein the catalyst is a hydrogenation metal catalyst.

Embodiment 3. The apparatus of Embodiment 2 wherein the hydrogenation metal catalyst is selected from a group consisting of Pt, Re, Co, Mo, Pd, Ni, Ir, Fe, and mixtures thereof.

Embodiment 4. The apparatus of any one of Embodiments 1-3 wherein the passivating agent is a sulfiding agent.

Embodiment 5. The apparatus of Embodiment 4 wherein the sulfiding agent is selected from the group consisting of carbon disulfide, n-butyl mercaptan, ethyl mercaptan, di-tertiary nonyl polysulfide, dimethyl disulfide, dimethyl sulfide, dimethyl sulfoxide, hydrogen sulfide, and mixtures thereof.

Embodiment 6. The apparatus of any one of Embodiments 1-5 wherein the inert gas is selected from the group consisting of N₂, He, Ne, Ar, H₂, natural gas, and mixtures thereof.

Embodiment 7. The apparatus of any one of Embodiments 1-6 wherein the conduits leading to and from the first container, second container, and reactor meet at an intersection separate from any vessel.

Embodiment 8. The apparatus of any one of Embodiments 1-6 wherein the first container feeds directly into the second container which feeds directly into the reactor in a linear path such that the contents of the first container cannot reach the reactor without passing through the second container.

Embodiment 9. An apparatus for passivating catalysts, consisting essentially of: (a) a container comprising at least one inert gas and at least one passivating agent; and (b) a reactor comprising at least one catalyst, wherein the container and reactor are fluidly connected by a plurality of conduits.

Embodiment 10. A process for passivating catalysts, which comprises: (a) pressurizing a first container with an inert gas; (b) filling a second container with a desired amount of passivating agent; (c) providing a reactor containing a passivatable catalyst; (d) causing the inert gas to mix with the passivating agent, thereby pressurizing the passivating agent and forming a mixture of passivating agent and inert gas; and (e) introducing the mixture of passivating agent and inert gas into the reactor.

Embodiment 11. The process of Embodiment 10 wherein the passivatable catalyst is a hydrogenation metal catalyst.

Embodiment 12. The process of Embodiment 11 wherein the hydrogenation metal catalyst is selected from a group consisting of Pt, Re, Co, Mo, Pd, Ni, Fe, Ir, and mixtures thereof.

Embodiment 13. The process of any one of Embodiments 10-12 wherein the passivating agent is a sulfiding agent.

Embodiment 14. The process of Embodiment 13 wherein the sulfiding agent is selected from the group consisting of carbon disulfide, n-butyl mercaptan, ethyl mercaptan, di-tertiary nonyl polysulfide, dimethyl disulfide, dimethyl sulfide, dimethyl sulfoxide, hydrogen sulfide, and mixtures thereof.

Embodiment 15. The process of any one of Embodiments 10-14 wherein the inert gas is selected from the group consisting of N₂, He, Ne, Ar, H₂, natural gas, and mixtures thereof.

Embodiment 16. The process of any one of Embodiments 10-15 wherein after introducing the mixture to the reactor, the second container is measured to determine the amount of passivating agent remaining in the container.

Embodiment 17. The process of Embodiment 16 wherein the method of measuring the amount of passivating agent remaining in the container after performing the process comprises comparing the weight of the container before and after performing the process.

Embodiment 18. The process of Embodiment 16 wherein the method of measuring the amount of passivating agent remaining in the container after performing the process comprises referencing an indicator on the container itself.

Embodiment 19. The process of Embodiment 16 wherein the method of measuring the amount of passivating agent used during the process is by weighing the second container while performing the process.

Embodiment 20. A process for passivating catalysts, which comprises: (a) introducing a desired amount of passivating agent into a container; (b) pressurizing the container with an inert gas; (c) providing a reactor containing a passivatable catalyst; and (d) introducing the mixture of passivating agent and inert gas into the reactor.

The invention has been described above with reference to numerous embodiments and specific examples. Many variations will suggest themselves to those skilled in this art in light of the above detailed description.

All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted. When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

What is claimed is:

1. An apparatus for passivating catalysts, consisting essentially of:
a. a first container comprising at least one inert gas,
b. a second container comprising at least one passivating agent, and
c. a reactor comprising at least one catalyst,
wherein the first container, second container, and reactor are fluidly connected by a plurality of conduits.

2. The apparatus according to claim 1 wherein the catalyst is a hydrogenation metal catalyst.

3. The apparatus according to claim 2 wherein the hydrogenation metal catalyst is selected from a group consisting of Pt, Re, Co, Mo, Pd, Ni, Fe, Ir and mixtures thereof.

4. The apparatus according to claim 1 wherein the passivating agent is a sulfiding agent.

5. The apparatus according to claim 4 wherein the sulfiding agent is selected from the group consisting of carbon disulfide, n-butyl mercaptan, ethyl mercaptan, di-tertiary nonyl polysulfide, dimethyl disulfide, dimethyl sulfide, dimethyl sulfoxide, hydrogen sulfide, and mixtures thereof.

6. The apparatus according to claim 1 wherein the inert gas is selected from the group consisting of N₂, He, Ne, Ar, H₂, natural gas, and mixtures thereof.

7. The apparatus according to claim 1 wherein the conduits leading to or from the first container, second container, and reactor meet at an intersection separate from any vessel.

8. The apparatus according to claim 1 wherein the first container feeds directly into the second container which feeds directly into the reactor in a linear path such that the contents of the first container cannot reach the reactor without passing through the second container.

9. An apparatus for passivating catalysts, consisting essentially of:
a. a container comprising at least one inert gas and at least one passivating agent, and
b. a reactor comprising at least one catalyst, wherein the container and reactor are fluidly connected by a plurality of conduits.

10. A process for passivating catalysts, which comprises:
a. pressurizing a first container with an inert gas;
b. filling a second container with a passivating agent;
c. providing a reactor containing a passivatable catalyst;
d. causing the inert gas to mix with the passivating agent, thereby pressurizing the passivating agent and forming a mixture of passivating agent and inert gas; and
e. introducing the mixture of passivating agent and inert gas into the reactor.

11. The process according to claim 10 wherein the passivatable catalyst is a hydrogenation metal catalyst.

12. The process according to claim 11 wherein the hydrogenation metal catalyst is selected from a group consisting of Pt, Re, Co, Mo, Pd, Ni, Fe, Ir and mixtures thereof.

13. The process according to claim 10 wherein the passivating agent is a sulfiding agent.

14. The process according to claim 13 wherein the sulfiding agent is selected from the group consisting of carbon disulfide, n-butyl mercaptan, ethyl mercaptan, di-tertiary nonyl polysulfide, dimethyl disulfide, dimethyl sulfide, dimethyl sulfoxide, hydrogen sulfide, and mixtures thereof.

15. The process according to claim 10 wherein the inert gas is selected from the group consisting of N₂, He, Ne, Ar, H₂, natural gas, and mixtures thereof.

16. The process according to claim 10 wherein after introducing the mixture the second container is measured to determine the amount of passivating agent remaining in the container.

17. The process according to claim 16 wherein the method of measuring the amount of passivating agent remaining in the container after performing the process comprises comparing the weight of the container before and after performing the process.

18. The process according to claim 16 wherein the method of measuring the amount of passivating agent remaining in the container after performing the process comprises referencing an indicator on the container itself.

19. The process according to claim 16 wherein the method of measuring the amount of passivating agent used during the process is by weighing the second container while performing the process.

20. A process for passivating catalysts, which comprises:
a. introducing a desired amount of passivating agent into a container;
b. pressurizing the container with an inert gas;
c. providing a reactor containing a passivatable catalyst; and
d. introducing the mixture of passivating agent and inert gas into the reactor.
